(19) United States
(12) Patent Application Publication
(10) Pub. No.: US 2013/0279513 A1
(43) Pub. Date: Oct. 24, 2013

(54) SYSTEMS AND METHODS FOR PSEUDO-LINK CREATION

(71) Applicant: Donald E. Eastlake, III, Milford, MA (US)

(72) Inventor: Donald E. Eastlake, III, Milford, MA (US)

(21) Appl. No.: 13/993,233

(22) PCT Filed: Dec. 5, 2011
(86) PCT No.: PCT/US11/63333

§ 371 Date: Jun. 11, 2013

Related U.S. Application Data
(60) Provisional application No. 61/422,155, filed on Dec. 11, 2010.

(51) Int. Cl. H04L 12/70

(52) U.S. Cl. CPC H04L 49/15
USPC 370/410

(57) ABSTRACT

Systems, methods and apparatus for pseudo-link creation. In some embodiments, a network device operates in a network comprising a first switch device and a second switch device. The switch device may receive a control message from the first switch device and selectively forward the control message to the second switch device so as to create a pseudo-link between the first switch device and the second switch device.

### RELATED APPLICATIONS

This application claims the benefit of U.S. Provisional Application No. 61/422,155, titled “Efficient Pseudo-Link Creation,” filed on Dec. 11, 2010, which is incorporated herein by reference.

This application discloses subject matter that is technically related to at least some of the subject matter disclosed in the following applications, each of which is incorporated herein by reference:

U.S. Provisional Application No. 61/401,365, titled “Computer Network Multi-Destination Frame and Switch State Reduction,” filed on Aug. 12, 2010;

International Application No. PCT/US11/47621, titled “Systems and Methods for Managing Network Address Information,” filed on Aug. 12, 2011;

U.S. Provisional Application No. 61/418,124, titled “Switching, RBridge, and ARP/ND Improvements,” filed on Nov. 30, 2010;

International Application No. PCT/US11/62731, titled “Systems and Methods for Recovery from Network Changes,” filed on Nov. 30, 2011; and

International Application No. PCT/US11/62678, titled “Systems and Methods for Multi-Level Switching of Data Frames,” filed on Nov. 30, 2011.

### BACKGROUND

### I. Computer Networks

In a computer network, a group of computers and/or other devices communicate with each other via one or more communication links. One example of a network includes a pair of end stations each having a network interface, where the interfaces are connected to each other via a point-to-point network link. Another example of a network is shown in FIG. 1 and includes multiple computers 105A-O each having one or more network interfaces. Each interface is connected to one or more other interfaces either directly or via one or more of switches 110A-D. For instance, as shown in FIG. 1, station 105A may be connected to station 105B via switch 110B, and station 105H may be connected to station 105I via a shared link to switch 110D. Yet another example of a network is the Internet, which is a network having many interconnected subnetworks.

Data to be transmitted, such as a file, is often divided into smaller units of data to be transmitted separately over one or more networks and re-assembled at a receiving computer. Each such unit of data is commonly called a “frame,” although it should be appreciated that data can be divided into frames in any suitable way, for example, according to any suitable communication protocol.

Any suitable communication link may be used to communicate data frames between network interfaces. For example, a link may be wired (e.g., electrical or optical) or wireless (e.g., radio, microwave, or infrared). A link may also be virtual (i.e., simulated).

Many network communication protocols have been developed over the years. A common model is the layered networking model, where communication functions are grouped into logical layers. For example, in an Open Systems Interconnection (OSI) model, there are seven layers arranged from top to bottom, each layer providing services to layers above and receiving services from layers below. For instance, Layer 2 (also known as the Data Link Layer) receives data transmission and reception services from Layer 1 (also known as the Physical Layer), and provides physical addressing services to Layer 3 (also known as the Network Layer).

Concepts of communications protocols layers, such as Layer 3 and Layer 2 of an OSI model, are explained in ITU-T (International Telecommunications Union—Telecommunications Standardization Sector) Recommendation X.200, “Information Technology—Open Systems Interconnection—Basic Reference Model: The Basic Model,” which is incorporated herein by reference.

### II. Local Area Networks

In a local area network (also referred to as a LAN or local network), frames may be delivered after transiting the network with source and destination Layer 2 addresses, or interface source and destination addresses, associated with the frames unchanged or changed only to a form easily convertible to the original Layer 2 addresses.

It should be appreciated that local networks need not be “local” in a geographical sense. A local network may include components located in a geographical area of any suitable size (e.g., including multiple cities, states, and/or countries), and may even include components in outer space.

### III. Types of Data Frames

Data frames traversing a network may be classified as being either “multi-destination” or “individually addressed.” A “multi-destination” frame is a frame addressed to multiple destinations (e.g., multiple network interfaces). By contrast, an “individually addressed” frame is a data frame addressed to a single destination (e.g., a single network interface), and is sometimes called a “unicast” frame.

There are different types of multi-destination frames. For example, a “broadcast” frame is a multi-destination frame intended to be delivered to all interfaces in a local network. As another example, a “multicast” frame is a multi-destination frame intended to be delivered to a subset of such interfaces.

In some instances, a multi-destination frame may, despite being addressed to multiple interfaces, be delivered to only one interface or none at all. For example, this may happen when one or more interfaces to which the multi-destination frame is addressed do not exist in the local network.

### IV. Virtualization

A local network may include one or more virtual components. In such a network, data frames may be encapsulated so as to have at least one inner encapsulated address corresponding to a virtual component and at least outer encapsulation address corresponding to a physical component on which the virtual component is running. Multiple layers of encapsulation may also be possible. Furthermore, links between network interfaces may traverse physical or simulated switches in such a way that, while some outer encapsulation addresses may be changed (e.g., per router hop), some inner encapsulated addresses may remain unchanged or only changed in an easily reversible fashion.

Similarly, one or more switches, each having one or more interfaces connected to a local network, may be virtual. In one example, one or more switches may be virtual computers running inside a physical computer or across multiple physical computers or inside or across multiple higher-level virtual computers. In another example, an entire local network may be virtually emulated inside a single physical computer, or between or among modules of one or more computers, physically aggregated on the same computer chip or chip(s), or the same board, or backplane, or boards, or backplanes, or within the same rack or cabinet, or within a computer center, or otherwise grouped.

Virtual stations inside a physical computer may interface with a switch in various ways. In one example, there may be a virtual switch (e.g., implemented by software) also inside the physical computer on which the virtual stations are running. The virtual stations may be connected to the virtual switch, which, in turn, may connect to a physical switch using a physical connection from the physical computer to the physical switch. In another example, there may be a protocol by which a virtual station's traffic is multiplexed over a physical connection to a physical switch, so that the virtual station may appear to be connected to the physical switch via virtual interfaces inside the physical switch. Other techniques, or combinations of these and other techniques, may also be used.

### V. Virtual LANs

A local network may be subdivided into multiple overlaid logical networks called Virtual LANs or VLANs. A local network divided into VLANs may have the same physical structure as if not so divided. However, each data frame may, in some fashion, be labeled or categorized to indicate a VLAN to which the data frame belongs. Furthermore, a network interface may, in some fashion, be restricted or categorized in some suitable manner, so that switches may only send frames of certain labeling or categorization through interfaces with corresponding categorization. For example, certain network interfaces may be associated a particular type of traffic associated with a subset of VLANs, such as input traffic or output traffic, so that only that type of traffic associated with that subset of VLANs is sent through the interfaces.

In a local network supporting such VLANs, there may be end stations or switches that are unaware of VLANs and that receive and transmit unlabeled frames on one or more network interfaces of the end stations or switches. Such an unlabeled frame may be classified by an interface of the first VLAN-aware switch at which the frame arrives, to indicate a VLAN to which the frame belongs. The classification may be based on one or more values of one or more fields within the frame. Moreover, there may be VLAN-aware end stations that receive and transmit VLAN-labeled frames on one or more network interfaces, and/or classify unlabeled frames received on one or more interfaces as being in one or more specific VLANs.

A VLAN may include nested sub-VLANs and, likewise, may be enclosed by other higher-level VLANs. Thus, a “network” in the present disclosure may refer to any physical or virtual network, which may or may not include one or more subnetworks, and may or may not be included in one or more other networks as a subnetwork.

### SUMMARY

Systems, methods and apparatus are provided for pseudo-link creation.

In some embodiments, a method is provided for use by at least one network device operating in a network, the network comprising at least a first switch device and a second switch device, the method comprising acts of: (a) receiving at least one control message from the first switch device; and (b) selectively forwarding the at least one control message to the second switch device so as to create a pseudo-link between the first switch device and the second switch device.

In some further embodiments, an apparatus is provided, comprising at least one network device operating in a network, the network comprising at least a first switch device and a second switch device, the at least one network device configured to perform acts of: (a) receiving at least one control message from the first switch device; and (b) selectively forwarding the at least one control message to the second switch device so as to create a pseudo-link between the first switch device and the second switch device.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The accompanying drawings are not necessarily drawn to scale. For purposes of clarity, not every component may be labeled in every drawing.

FIG. 1 shows an example of an illustrative network having connected thereto multiple computers.

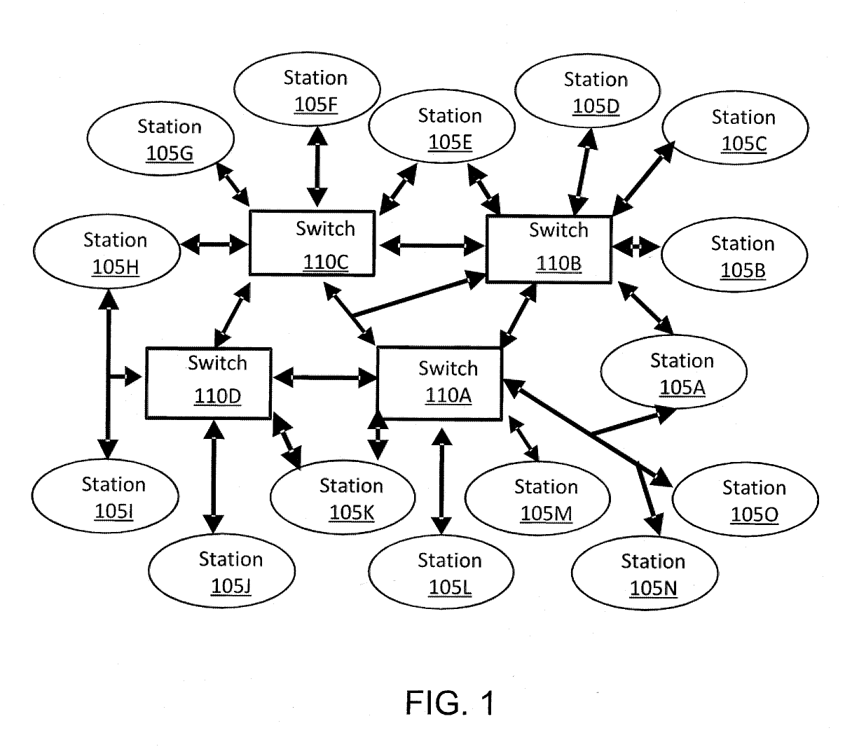

FIG. 2 shows an illustrative data structure that can be used for a type of protocol messages called “Hello” messages, in accordance with some embodiments.

FIG. 3 shows an example in which an end station receives services from multiple switch devices in a network, in accordance with some embodiments.

FIG. 4 shows an example in which a pseudo-link is created between two switch devices, in accordance with some embodiments.

FIG. 5 shows an illustrative process that can be performed by a network device to create a pseudo-link between two or more switch devices, in accordance with some embodiments.

FIG. 6 shows, schematically, an illustrative computer on which various inventive aspects of the present disclosure may be implemented.

### DETAILED DESCRIPTION

Link state routing is a technique used in a network of switches to forward traffic in an area of that network. A switch in the area may have information on some or all other switches in the area. For example, in some embodiments, a first switch may have information regarding connectivity at a second switch, which may indicate a set of one or more third switches with which the second switch detects a direct connection (which may be physical or simulated), and a measure of cost of traversing the direct connection between the second switch and each of the one or more third switches. In some further embodiments, every switch in the area may have such connectivity information regarding every other switch in the area. These connections may be called “links” and the connectivity information may be stored in a “link-state database,” which may or may not store other information.

Specific examples of link-state routing include IS-IS and OSPF. “IS-IS” refers to the Intermediate System to Intermediate System routing protocol standard whose specification includes ISO/IEC 10589:2002 (“Intermediate System to Intermediate System Intra-Domain Routing Information Exchange Protocol for Use in Conjunction with the Protocol for Providing the Connectionless-Mode Network Service (ISO 8473)”), which is incorporated herein by reference. The IS-IS standard is further extended by IETF (Internet Engineering Task Force) RFC 1195 (“Use of OSI IS-IS for Routing in TCP/IP and Dual Environments”) and IETF RFC 6165 (“Extensions to IS-IS for Layer-2 Systems”), each of which is incorporated herein by reference. “OSPF” refers to the Open Shortest Path First routing protocol standard whose specification includes IETF RFC 2328 (“OSPF Version 2”), which is incorporated herein by reference.

In some link-state routing embodiments, each switch may maintain a copy of a link-state database. In a quiescent network, these copies may eventually become identical at every switch, which may enable each switch to independently calculate (1) if the location of a frame's destination is known, a next switch to forward the frame towards the destination so that the frame may follow a least-cost path, or a set of next switches if there are equal cost multiple paths (ECMPs) that are associated with the lowest cost, and (2) one or more distribution trees, or other suitable distribution information, so the switch may forward multi-destination frames appropriately to zero, one, or multiple neighbors.

In some embodiments, connectivity database information may be developed for each link by the switches connected to that link using a protocol local to the link, which protocol may be part of an overall link-state protocol in use. Each switch may originate a part of the link-state database that includes the connectivity to other immediate neighbor switches that the switch detects out its ports. The switch may also store any other suitable information in the link-state database, as aspects of the present disclosure are not limited in this respect. For instance, for the IETF (Internet Engineering Task Force) TRILL (Transparent Interconnection of Lots of Links) protocol, which is based on the IS-IS link-state routing protocol, a link-state database may include information about the VLANs from which multi-destination traffic is to be received by the switch, information on the BPDU (Bridge Protocol Data Unit) Root Bridge information that the switch is receiving, and/or any other suitable information.

The IETF TRILL protocol standard's base specification includes the following IETF RFCs that are incorporated herein by reference:

RFC 6325 (“Routing Bridges (RBridges): Base Protocol Specification”);

RFC 6326 (“Transparent Interconnection of Lots of Links (TRILL) Use of IS-IS”);

RFC 6327 (“Routing Bridges (RBridges): Adjacency”); and

RFC 6439 (“Routing Bridges (RBridges): Appointed Forwarders”).

In some further embodiments, information contributed by each switch in a link-state routing area may be labeled with an identity of an originating switch and a version number, so updates may be reliably distinguished. Such information may be distributed to all other link-state switches in the area by a “reliable flooding” protocol. In some embodiments, reliable flooding may include techniques such as advertisement, on local links by a switch, of the origin and version of each piece of the link-state database held by that switch, and transmission of updates or missing pieces of information to immediate neighbor switches when such advertisement shows that one or more switches on the link is missing such information or updates to such information. Because of the large quantity of information that may be originated by a switch, such information may be fragmented into smaller, more manageable pieces, each of which is versioned separately and may be flooded separately.

The inventor has recognized and appreciated that, if a link has attached thereto K link-state switch devices (e.g., routers, bridges, or RBridges), any pair of switch devices among the K switch devices may be able to communicate over the link. Thus, the presence of such a link may give rise to (K²−K)/2 pairs of connected switch devices, which is on the order of K². As K increases, the amount of information stored in a link-state database and/or reported over the network regarding these connections may become very large.

Accordingly, in some embodiments, a “pseudo-node” (or, interchangeably, “virtual node” or “simulated node”) may be created to reduce the amount of connectivity information stored in a link-state database and/or reported over a network. For example, in one implementation, K switch devices attached to a link may report in a link-state database that the switch devices are connected to a common pseudo-node, and a designated one of the K switch devices may report state data as if the designated switch device were the pseudo-node, thereby reporting connectivity information to all of the K switch devices. This may change the number of connectivity reports from (K²−K)/2 to K, which represents a reduction for any K greater than 3.

The inventor has further recognized and appreciated that, a switch device in a network using link-state routing may, in some instances, be incapable of building, storing, and/or maintaining an entire link-state database. This may be due to lack of resources (e.g., storage capacity). As a result, it may be undesirable to rely on such a switch device to route transit frames properly. However, such a switch device may still be used as a first or last router in a routed path for a frame. Accordingly, in some embodiments, link-state information for a switch may be set to indicate that the switch is an “overflow” state. This may indicate to other network devices participating in a link-state routing protocol (e.g., a protocol based on IS-IS or OSPF) that frames are to be routed on paths that avoid the switch in overflow state in strict preference to paths that include the switch in overflow state.

A switch may be placed in an overflow state for various reasons. In one example, a switch may be placed in an overflow state due to actual overflow (e.g., the switch being unable to hold an entire link-state database). In another example, a switch may be placed in an overflow state by network management because maintenance is being performed on the switch. For instance, during some maintenance routines, it may be desirable for the switch to be able to receive and transmit maintenance messages, but the switch may not be trusted to properly handle through traffic.

Following below are more detailed descriptions of various concepts related to, and embodiments of, inventive systems, methods and apparatus for pseudo-link creation. It should be appreciated that various concepts introduced above and discussed in greater detail below may be implemented in any of numerous ways, as the disclosed concepts are not limited to any particular manner of implementation. For instance, the present disclosure is not limited to the particular arrangements of components shown in the various figures, as other arrangements may also be suitable. Such examples of specific implementations and applications are provided solely for illustrative purposes.

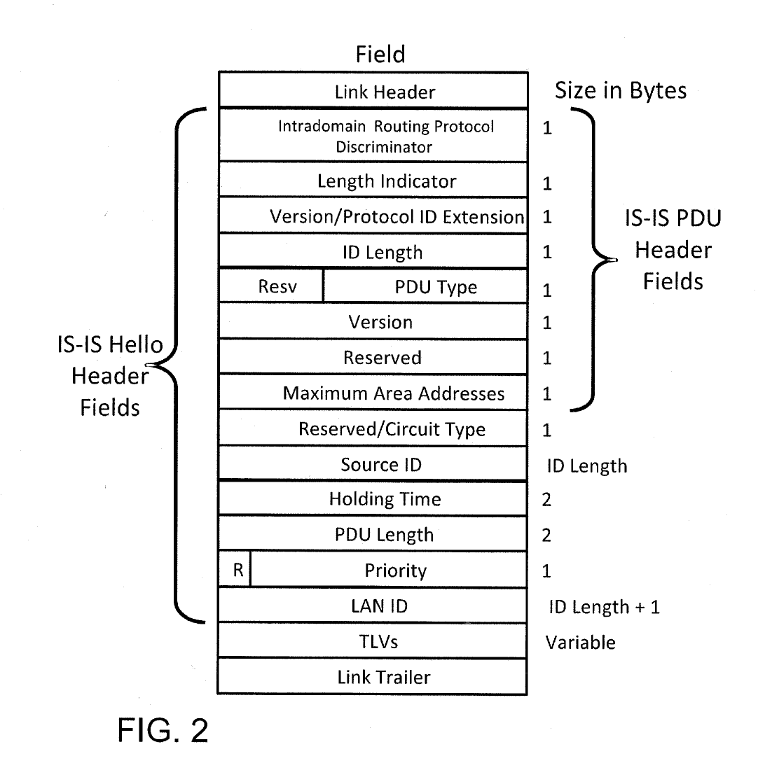

FIG. 2 shows an illustrative data structure for an IS-IS “Hello” message that can be used to determine local connectivity on a link, in accordance with some embodiments. In this example, the Hello message begins with a Link Header and ends with a Link Trailer that are appropriate for a corresponding link technology type. For instance, for an Ethernet link, a Link Header may include an appropriate multicast Media Access Control (MAC) destination address, followed by a MAC source address of a port from which the Hello message was sent. In some further embodiments, the MAC source address may be followed by a VLAN tag and/or other tags, and then a Logical Link Control (LLC) or EtherType encoding of a payload type. The LLC encoding may include a payload length (which may be a two-byte value) followed by three bytes for, respectively, Destination Service Access Point (DSAP), Source Service Access Point (SSAP), and Control. In one implementation, the three bytes are 0xFE, 0xFE, and 0x03. In yet some further embodiments, the EtherType encoding may include an L2-IS-IS EtherType (e.g., 0x22F4), while the Link Trailer for Ethernet may be a 4-byte Frame Check Sequence (FCS).

In some embodiments, the information in a Hello message between a header and a trailer may start with one or more IS-IS Hello fields that may in turn start with one or more fields for one or more IS-IS PDUs (Protocol Data Units). The PDU fields may in turn start with a one byte Intradomain Routing Protocol Discriminator that is a byte of value 0x83. Thus, if IS-IS is LLC encoded, a six-byte sequence may be observed, namely, a two-byte payload length followed by 0xFE, 0xFE, 0x03, 0x83. If instead EtherType encoding is used, a three-byte sequence may be observed, namely, 0x22, 0×F4, 0x83.

In some embodiments, the PDU fields may further include a PDU Type field, which may be 15 to indicate a Level 1 IS-IS Hello PDU or 16 to indicate a Level 2 IS-IS Hello PDU. It should be appreciated that various techniques described herein are not limited any particular PDU Type value, as other values may also be suitable. Finally, the PDU fields may include a Source ID field, which may identify a switch sending the Hello message and indicate connectivity from that switch to a receiving switch, and a TLVs area, which may include a variety of information encoded in a TLV (Type, Length, Value) format.

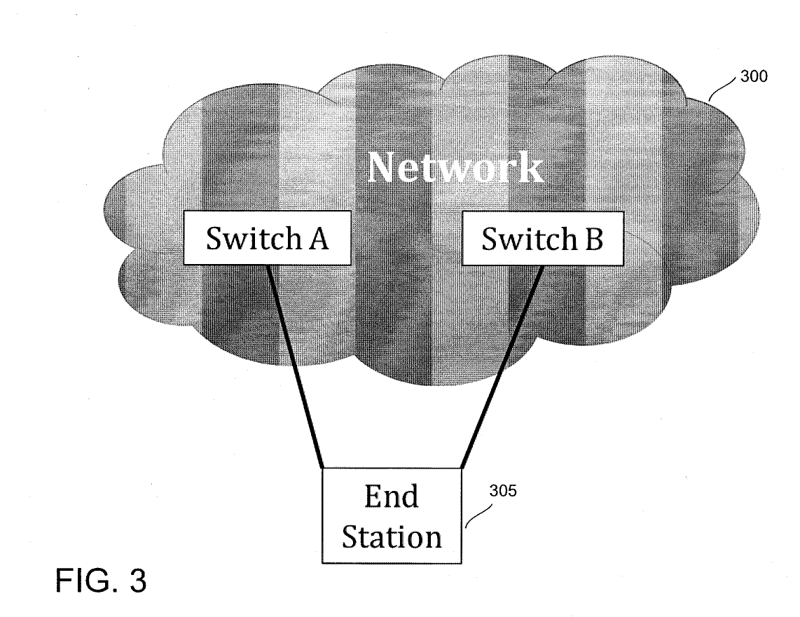

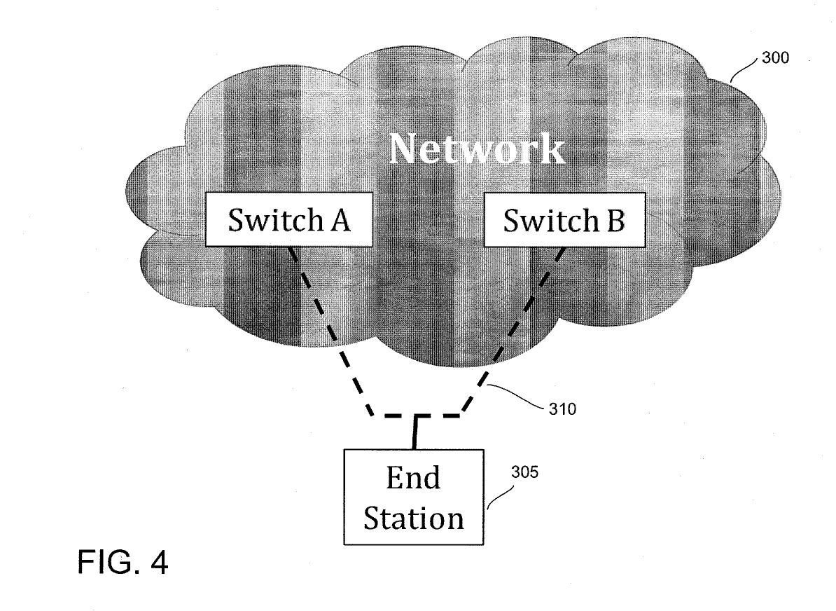

The inventor has recognized and appreciated that multiple separate links in a network may be combined into a single “pseudo-link” (or, interchangeably, “virtual link” or “simulated link”) for such purposes as rapid failover and local address assignment. Various advantages of creating such a pseudo-link are discussed in greater detail below in connection with FIGS. 3-4.

FIG. 3 shows an example in which an end station 305 receives services from multiple switch devices in a network 300, in accordance with some embodiments. For instance, the end station 305 may receive network service via either Switch A or Switch B shown in FIG. 3. However, it should be appreciated that, although not shown in FIG. 3, the end station 305 may additionally be connected to one or more switch devices in the network 300 other than Switch A and Switch B. Furthermore, the network 300 may include one or more end stations other than the end station 305 that are also connected to multiple switch devices in the network 300.

In the example of FIG. 3, the multiple connections available to the end station 305 may provide redundancy and thereby improve reliability of service. For instance, in case of failure of one of Switch A and Switch B, or failure of a link from one of Switch A and Switch B to the end station 305, the remaining connection may take over and provide services to the end station 305.

However, in systems such as IETF TRILL and IEEE (Institute for Electrical and Electronic Engineers) 802.1 Shortest Path Bridging (SPB), address learning in remote parts of a network may be based on a designated final switch device that actually delivers data to an end station, or in some similar way be related to a network device leading to the end station. For example, with reference to FIG. 3, Switch A may be the designated switch device that delivers data to the end station 305. If Switch A fails, or a link between Switch A and the end station 305 fails, it may be difficult to update address learning information to indicate, for example, that data should flow to the end station 305 via Switch B instead of Switch A, because such address learning information may be scattered all over the network 300.

Accordingly, in some embodiments, address learning may be performed based on a final link, rather than a final switch device, leading to an end station. For instance, in a system using link-state routing (e.g. TRILL or SPB), a link may be identified as a pseudo-node, so that address learning may be based on final links leading to end stations. Such a link may have multiple switches attached thereto, in addition to one or more end stations. A frame addressed to the link may arrive at any of the switches on the link, for example, a switch associated with a least cost from an origin of the frame elsewhere in the network. Should one of the switches on the link, or the connection from that switch to the link, fail, one or more link-state routing mechanisms may soon cause all frames addressed to the link to be delivered to one of the other switches on the link, and not to the switch associated with the failure. An example is shown in FIG. 4, where address learning may be based on a virtual link 310 leading to the end station 305. This may be done, for instance, using a nickname for a pseudo-node identifying the virtual link 310 as an egress nickname in a TRILL Header in a frame destined for the end station 305. That this pseudo-node nickname is to be used may be learned in any suitable manner. For example, whenever Switch A or Switch B ingresses a frame from the end station 305, this pseudo-node nickname may be used as an ingress nickname in a TRILL Header of the frame, rather than the nickname of the switch (e.g., Switch A or Switch B) that actually ingresses the frame.

In some further embodiments, delivery of frames may be adjusted in some appropriate manner for loop avoidance. For example, with TRILL, a known unicast frame or a multi-destination frame egressed onto a link by a network device other than an appointed forwarder for a VLAN of the frame may be ingressed by the appointed forwarder, thereby resulting in a loop. Thus, to avoid looping, such a frame may instead be forwarded as a TRILL Data frame to the appointed forwarder for final delivery.

In yet some further embodiments, in a system where local MAC addresses are assigned with topological significance, such assignment may be from a part of a MAC address space associated with a final link, rather than a part of the MAC address space associated with a final switch device. In this manner, a MAC address may remain assigned to an end station on a link even if a particular switch device providing access to that link fails.

The inventor has further recognized and appreciated that, even if address learning is performed based on final links rather than final switch devices, updating address learning information may still be difficult in the example of FIG. 3 because there are two separate links that may have separate pseudo-node identities. Therefore, it may be desirable to combine the two separate links into a single pseudo-link.

Accordingly, in some embodiments, techniques are provided to cause the network 300 and Switches A and B to act as if there is a single pseudo-link 310, as illustrated in FIG. 4. In this manner, address learning information for the end station 305 may remain unchanged even if Switch A or Switch B fails, and hence there may be no need to update address learning information throughout the network 300 to recover from the failure. Likewise, in an embodiment in which addresses are locally assigned, an address assigned to an end station may remain unchanged even if a switch device leading to the end station fails.

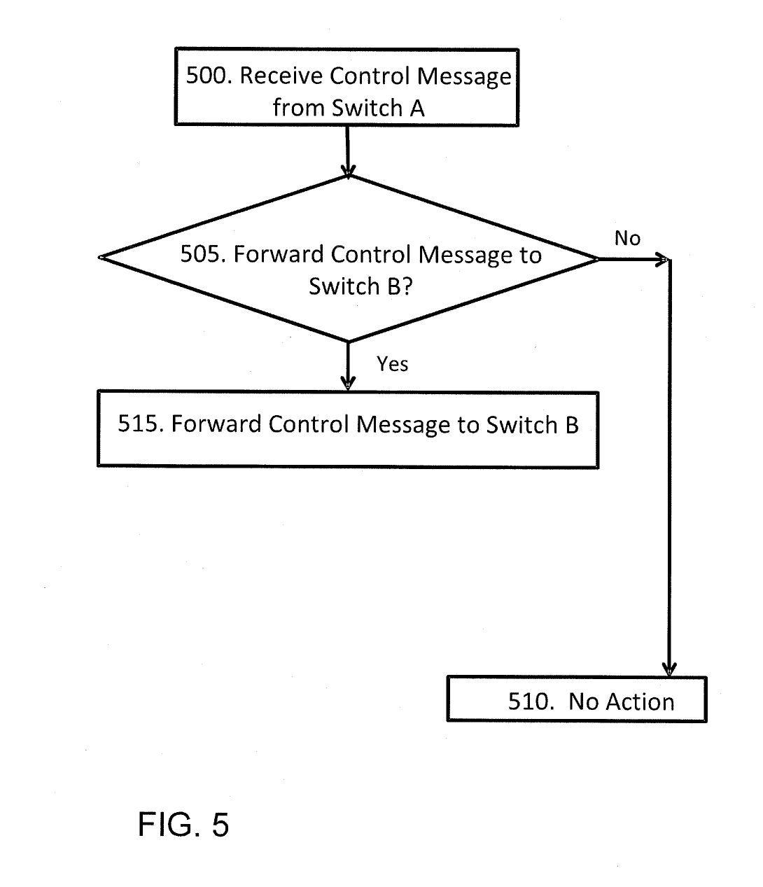

FIG. 5 shows an illustrative process that can be performed by a network device to create a pseudo-link between two or more switch devices, in accordance with some embodiments. For instance, this process may be used by the end station 305 in the example of FIG. 4 to create the pseudo-link 310 between Switches A and B.

At step 500, the end station 305 may receive a control message sent by Switch A. At step 505, the end station 305 may examine the received control message to determine whether to forward the message to Switch B. For example, the end station 305 may decide to forward the message if the message is a connectivity discovery or link test message.

If the end station 305 determines at the step 505 that the control message is not to be forwarded to Switch B, the process proceeds to step 510 and no further action is taken. If, instead, the end station 305 determines at the step 505 that the control message is to be forwarded to Switch B, the process proceeds to step 515 and the end station 305 forwards the control message to Switch B.

It should be appreciated that the illustrative process of FIG. 5 may be performed by the end station 305 not only to forward control messages from Switch A to Switch, but also vice versa. Indeed, the process of FIG. 5 may be performed by the end station 305, or any other suitable network device, to forward control messages between any suitable set of two or more switch devices. Such forwarding may emulate a single multi-access link between the switch devices. For instance, from Switch A's perspective, the control messages may appear as if they had be sent directly from Switch B, and vice versa.

In some further embodiments, a pseudo-node may be added to a link-state database that corresponds to the pseudo-link 310. For instance, a DIS (Designated Intermediate System for IS-IS) may create and flood an entry in the link-state database for the pseudo-link 310. Other switch devices on the pseudo-link 310 may cooperate by reporting their connectivity information to the pseudo-node. The DIS creating the pseudo-node by adding link-state database entries may also announce the pseudo-node on the pseudo-link 310.

The DIS may be a switch device that is elected among switch devices on the pseudo-link 310 to perform certain duties. For instance, the DIS may send out on the link a periodic CSNP (Complete Sequence Number PDU) listing all link-state database fragments the DIS is holding and sequence numbers corresponding to the fragments. Additionally, or alternatively, the DIS may send a CSNP when a change in the link-state database is detected. The DIS may further respond to PSNPs (Partial Sequence Number PDUs) sent by other switch devices on the link requesting link-state database fragments. The DIS may further create a pseudo-node for the link by creating appropriate link-state data. In some implementations of TRILL, the DIS is called a DRB (Designated RBridge) and has additional duties beyond those of a base IS-IS DIS.

In some yet further embodiments, the end station 305 may modify received control messages prior to forwarding them between Switch A and Switch B. This may be done to control some aspects of the pseudo-link 310. For example, if the network 300 uses TRILL, it may not be appropriate for the end station 305 to be a general conduit for through traffic. Accordingly, the end station 305 may forward TRILL Hello messages only if the messages have the “Access Port” bit on, indicating that Switch A and B will not use any discovered link for through traffic but only for end station service. Alternatively, the end station 305 may set the Access Port bit in such Hello messages, if the Hello messages are not secured, or if the end station 305 has sufficient security information for modifying the Hello messages. Additionally, if TRILL Maximum Transmission Unit (MTU) testing is in effect, the end station 305 may forward or respond to MTU test messages.

In yet some further embodiments, where an IS-IS or OSPF link-state routing protocol is used, through traffic may be inhibited by setting an “overflow” bit in the link-state information associated with a pseudo-node corresponding to the pseudo-link 310.

It should be appreciated that the techniques described above for combining separate links into a single pseudo-link are merely illustrative, as aspects of the present disclosure are not limited to the use of any particular technique for creating a pseudo link. For example, in alternate embodiments, forwarding of Hello messages may be done by simulating a bridge inside the end station 305, where the simulated bridge may be configured to selectively forward some or all control messages. The simulated bridge may be further configured not to forward any data message.

The inventor has recognized and appreciated that the use of labels (e.g., TRILL nicknames or SPB SPSourceIDs) for pseudo-nodes associated with pseudo-links or links may consume a large number of such labels. These labels may be abbreviations of (and, as such, may be shorter than) IS-IS system IDs, so these labels may run out more quickly.

However, the inventor has further recognized and appreciated that different pseudo-links having attached thereto exactly the same set of switch devices (e.g., RBridges) need not have different labels. Accordingly, in some embodiments, the same label may be used for a set of two or more such pseudo-links. A data frame intended for either pseudo-link may arrive at a first switch device of the set of switch devices attached to the set of pseudo-links, and the first switch device may either directly egress the frame, or forward the frame to a selected second switch device in the set of switch devices attached to any pseudo-link of the set of pseudo-links. In some further embodiments, this forwarding may be accompanied, if desired, by altering an egress nickname to that of the second switch device.

In some embodiments, an appropriate network switch to provide such shared nicknames for two or more pseudo-links may be an IS-IS DIS on a pseudo-link or pseudo-links, or a switch device playing a similar role for other link-state routing protocols.

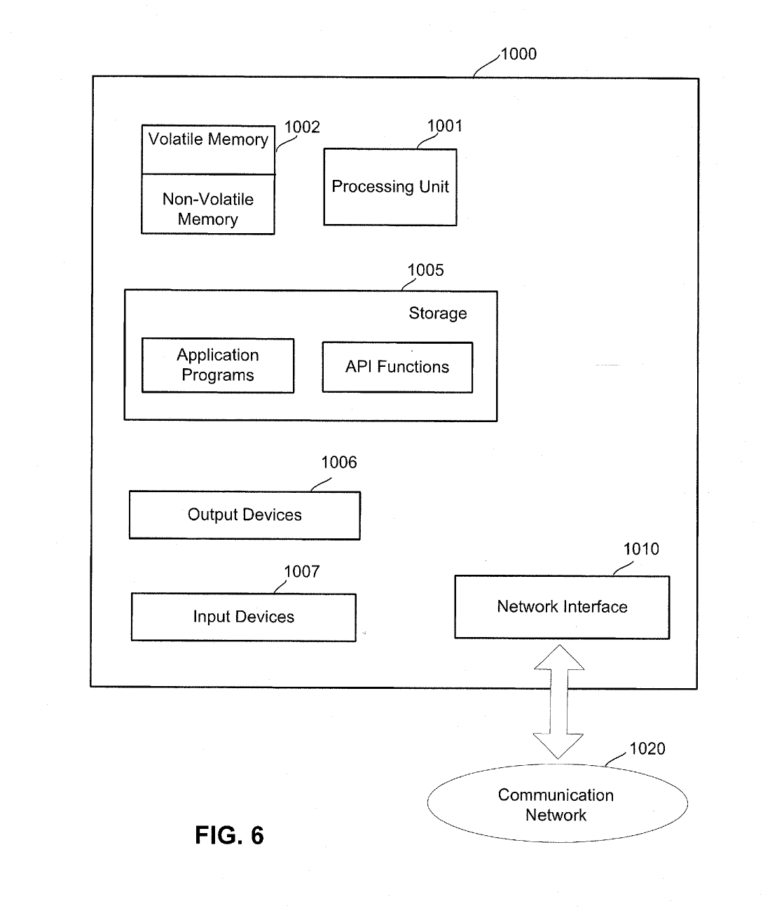

FIG. 6 shows, schematically, an illustrative computer 1000 on which various inventive aspects of the present disclosure may be implemented. The computer 1000 may include a processor or processing unit 1001 and a memory 1002 that may include volatile and/or non-volatile memory. The computer 1000 may also include storage 1005 (e.g., one or more disk drives) in addition to the system memory 1002. The memory 1002 may store one or more instructions to program the processing unit 1001 to perform any of the functions described herein. The memory 1002 may also store one more application programs and/or Application Programming Interface (API) functions.

The computer 1000 may have one or more input devices and/or output devices, such as devices 1006 and 1007 illustrated in FIG. 6. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

As shown in FIG. 6, the computer 1000 may also comprise one or more network interfaces (e.g., the network interface 1010) to enable communication via various networks (e.g., the network 1020). Examples of networks include a local area network or a wide area network, such as an enterprise network or the Internet. Such networks may be based on any suitable technology and may operate according to any suitable protocol and may include wireless networks, wired networks or fiber optic networks. Examples of local networks include, but are not limited to, bridged LANs and RBridged campuses.

Finally, the computer 1000 may be a mobile device that is sufficiently small so as to be carried by a user (e.g., held in a hand of the user). Examples of mobile devices include, but are not limited to, mobile phones, pagers, portable media players, e-book readers, handheld game consoles, personal digital assistants (PDAs) and tablet computers. In some instances, the weight of a mobile device may be at most one pound, and/or the largest dimension of a mobile device may be at most six inches. Additionally, a mobile device may include features that enable the user to use the device at diverse locations. For example, a mobile device may include a power storage device (e.g., battery) so that it may be used for some duration without being plugged into a power outlet. As another example, a mobile device may include a wireless network interface configured to provide a network connection without being physically connected to a network connection point.

The illustrative computer 1000 shown in FIG. 6 may be used to implement a switch device in a network receives and transmits frames of data through network interfaces. Examples of switch devices include, but are not limited to, the following:
Bridges: For example, a bridge device may be generally conformant to any of IEEE (Institute of Electrical and Electronics Engineers) 802.1 bridging standards, including, but not limited to, IEEE 802.1D-2004, “IEEE Standard for Local and Metropolitan Area Networks/Media Access Control (MAC) Bridges,” and IEEE 802.1Q-2011, “Standard for Local and Metropolitan Area Networks/Virtual Bridged Local Area Networks,” which are incorporated herein by reference. It should be appreciated that a device conformant to a future IEEE 802.1 bridging standard, or a bridging standard developed by some other standard setting organization, may also be considered a “bridge,” as aspects of the present disclosure are not limited to conformance to any particular bridging standard, nor to conformance to any standard at all. For example, a bridge device may be a device conformant to a specification for Shortest Path Bridges, which is being developed as an extension of IEEE 802.1, and uses a link state protocol to configure bridging mechanisms.
RBridges: For example, an RBridge device may be generally conformant to IETF (Internet Engineering Task Force) TRILL (TRansparent Interconnection of Lots of Links) standard as set out in IETF RFCs 6325, 6326, and 6327, which are incorporated herein by reference. Again, it should be appreciated that aspects of the present disclosure are not limited to conformance to any particular standard or version of a standard for an RBridge device, nor to conformance to any standard at all.
Routers: For example, a router device may forward or deliver data frames based on Layer 3 addresses specified in the frames. Because local networks use Layer 2 addresses to deliver a frame to a next router or final destination, a router may, on a per-router-hop basis, map Layer 3 addresses to Layer 2 addresses. In some instances, the router may change an outer Layer 2 address of the data frame to transport the frame to the next router or final destination.
Any other network devices adapted to route, forward, and/or deliver frames of data to one or more target interfaces (i.e., network interfaces to which the frames are addressed), or at least attempt to route, forward, and/or deliver the frames closer to the target interfaces.
Any combination of the above. This includes, for example, a BRouter, which is a device adapted to route frames whose Layer 3 addressing protocols are understood by the BRouter, and to bridge all other frames.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

1. A method for use by at least one network device operating in a network, the network comprising at least a first switch device and a second switch device, the method comprising acts of:
(a) receiving at least one control message from the first switch device; and
(b) selectively forwarding the at least one control message to the second switch device so as to create a pseudo-link between the first switch device and the second switch device.

2. The method of claim 1, wherein the first and second switch devices participate in at least one routing protocol, and wherein the at least one control message is sent by the first switch device as part of the at least one routing protocol.

3. The method of claim 2, wherein the at least one routing protocol is based on Intermediate System to Intermediate System (IS-IS).

4. The method of claim 3, wherein the at least one routing protocol is based on Internet Engineering Task Force (IETF) Transparent Interconnection of Lots of Links (TRILL).

5. (canceled)

6. The method of claim 2, wherein the at least one routing protocol is based on IETF Open Shortest Path First (OSPF).

7. The method of claim 1, further comprising an act of:
(c) adding a link-state pseudo-node to a link-state database, the pseudo-node corresponding to the pseudo-link created between the first and second switch devices.

8. The method of claim 7, wherein the act (c) comprises an act of:
(d) setting a link-state overflow bit in the link-state pseudo-node corresponding to the pseudo-link.

9. The method of claim 1, wherein the act (b) comprises an act of:
(e) determining, based at least in part on a type of the at least one control message, whether to forward the at least one control message to the second switch device.

10. The method of claim 9, wherein the act (b) further comprises an act of:
(f) forwarding the at least one control message to the second switch device when it is determined that the at least one control message comprises a connectivity discovery message.

11. The method of claim 9, wherein the act (b) further comprises an act of:
(f) forwarding the at least one control message to the second switch device when it is determined that the at least one control message comprises a link test message.

12-15. (canceled)

16. An apparatus comprising at least one network device operating in a network, the network comprising at least a first switch device and a second switch device, the at least one network device configured to perform acts of:
(a) receiving at least one control message from the first switch device; and
(b) selectively forwarding the at least one control message to the second switch device so as to create a pseudo-link between the first switch device and the second switch device.

17. The apparatus of claim 16, wherein the first and second switch devices participate in at least one routing protocol, and wherein the at least one control message is sent by the first switch device as part of the at least one routing protocol.

18. The apparatus of claim 17, wherein the at least one routing protocol is based on Intermediate System to Intermediate System (IS-IS).

19. The apparatus of claim 18, wherein the at least one routing protocol is based on Internet Engineering Task Force (IETF) Transparent Interconnection of Lots of Links (TRILL).

20. (canceled)

21. The apparatus of claim 17, wherein the at least one routing protocol is based on IETF Open Shortest Path First (OSPF).

22. The apparatus of claim 16, wherein the at least one network device is further configured to perform an act of:
(c) adding a link-state pseudo-node to a link-state database, the pseudo-node corresponding to the pseudo-link created between the first and second switch devices.

23. The apparatus of claim 22, wherein the act (c) comprises an act of:
(d) setting a link-state overflow bit in the link-state pseudo-node corresponding to the pseudo-link.

24. The apparatus of claim 16, wherein the act (b) comprises an act of:
(e) determining, based at least in part on a type of the at least one control message, whether to forward the at least one control message to the second switch device.

25. The apparatus of claim 24, wherein the act (b) further comprises an act of:
(f) forwarding the at least one control message to the second switch device when it is determined that the at least one control message comprises a connectivity discovery message.

26. The apparatus of claim 24, wherein the act (b) further comprises an act of:
(f) forwarding the at least one control message to the second switch device when it is determined that the at least one control message comprises a link test message.

27-30. (canceled)
